(19) United States
(12) Patent Application Publication
(10) Pub. No.: US 2002/0026852 A1
(43) Pub. Date: Mar. 7, 2002

(54) Wave gear drive unit

(76) Inventors: Yoshihide Kiyosawa, Nagano-ken (JP); Toshimi Yamagishi, Nagano-ken (JP)

Correspondence Address: William C. Rowland, BURNS, DOANE, SWECKER & MATHIS, L.L.P., P.O. BOX 1404, Alexandria, VA, 22313-1404, US

(21) Appl. No.: 09/899,858

(22) Filed: Jul. 9, 2001

(30) Foreign Application Priority Data
Jul. 10, 2000 (JP) P-2000-208058

(51) Int. Cl. F16H 1/32

(52) U.S. Cl. 74/640

(57) ABSTRACT

A wave gear drive unit 1 has a unit case 2, a wave reduction gear mechanism 3 disposed inside the unit case 2, an input shaft 4 and an output shaft 5. The output shaft 5 is integrally formed on a boss 323 of a cup-shaped flexible external gear 32 of the mechanism 3 and extends through a second end plate 5 to project outside. The boss 323 is screwed into the second end plate 22. A cross roller bearing 6 is constituted by the outer circumferential surface of the boss 323 and the inner circumferential surface of the unit case, by measn of which the second end plate 22 is rotatably supported on the unit case 2. The wave gear drive unit 1 has a simple structure with a small number of assembled parts, and can be assembled easily.

### BACKGROUND OF THE INVENTION

1. Field of the Invention

This invention relates to a wave gear drive unit having a unit case and a wave reduction gear mechanism which is housed in the unit case and an output shaft thereof projects from one end of the unit case. In particular, this invention pertains to a wave gear drive unit which is small and compact, and can easily be assembled.

2. Related Art Description

A typical wave gear drive unit has a unit case, a wave reduction gear mechanism disposed inside the unit case, an input shaft of high rotational speed and an output shaft of reduced rotational speed. The unit case has an annular case body, and first and second end plates respectively attached on both open ends of the case body. The input shaft penetrates through the first end plate and is connected to a wave generator as the input element of the wave reduction gear mechanism, while the output shaft is connected at its base end to a cup-shaped flexible external gear as the output element of the wave reduction gear mechanism and penetrates through the second end plate to project outward.

Generally, the wave reduction gear mechanism has a circular rigid internal gear, a cup-shaped flexible external gear inside the rigid internal gear, and an elliptical-shaped wave generator fixed inside the flexible external gear. The flexible external gear is flexed elliptically by the wave generator so that it meshes with the rigid internal gear at both end portions of the major axis of the elliptical shape. As the wave generator is rotated by a motor or the like, the meshing portions of the both gears moves circumferentially, whereby the both gears rotates relatively at a greatly reduced rotational speed according to the difference in the number of teeth between the both gears. The rigid internal gear is fixedly mounted on the unit case, and an rotational output of greatly reduced speed is derived from the flexible external gear.

The cup-shaped flexible external gear has an annular body, a circular diaphragm plate extending radially and inward from one end of the body, and a boss integrally formed on an inner peripheral edge of the diaphragm plate, wherein external teeth are formed on an outer circumferential surface portion of the body at the side opposite to the diaphragm plate. The output shaft is connected coaxially to a circular end surface of the boss by means of fastening bolts or the like.

### SUMMARY OF THE INVENTION

An object of this invention is to provide a small and compact wave gear drive unit.

The other object of this invention is to provide a wave gear drive unit which can easily be assembled.

Another object of this invention is to provide a wave gear drive, an output-shaft connecting portion of which is compact and can easily be assembled.

In order to realize the above and other objects, according to this invention, there is provided a wave gear drive unit comprising:

a unit case;

a wave reduction gear mechanism disposed inside the unit case;

an input shaft;

an output shaft;

wherein the unit case has an annular case body, a first end plate attached on one end of the case body, and a second end plate rotatably supported on the other end of the case body,

wherein the wave reduction gear mechanism has a circular rigid internal gear, a cup-shaped flexbile external gear disposed inside the rigid internal gear, a wave generator for flexing the flexible external gear radially to mesh it partially with the rigid internal gear and for moving meshing portions of these gears circumferentially,

wherein the input shaft is conencted coaxially with the wave generator and penetrates rotataby through the first end plate,

wherein the flexible external gear has an annular body, a circular diaphragm plate extending radially and inward from one end of the body, and a disk-shaped boss integrally formed on an inner peripheral edge of the diaphragm plate, and

wherein the output shaft is integrally formed on the boss and penetrates through the second end plate.

It is preferable for the boss to screw into the second end plate, whereby connection between the flexible external gear and the second end plate can be made small and compact in comparison to the case where fastening means such as fastening bolts is used.

It is also preferable to employ a cross roller bearing for supporting the second end plate rotatably on the case body. In this case, it is preferable that the cross roller bearing has an outer raceway surface formed on an inner circumferential surface of the case body, an inner raceway surface formed on an outer circumferential surface of the second end plate, and a plurality of rollers accommodated between these raceway surfaces. With this structure, since separate outer and inner races need not be assembled, the wave gear drive unit can be made compact in structure and can easily be assembled.

It is also preferable that the wave generator is formed with the input shaft integrally.

### BRIEF DESCRIPTION OF THE DRAWINGS

FIG. 1 is a sectional view of an example of a wave gear drive unit according to this invention, and

FIG. 2 is an end view of the wave gear drive unit of FIG. 1.

### DETAILED DESCRIPTION OF THE PREFERRED EMBODIMENT

With reference to the drawings, an example of a wave gear drive unit according to this invention will be described.

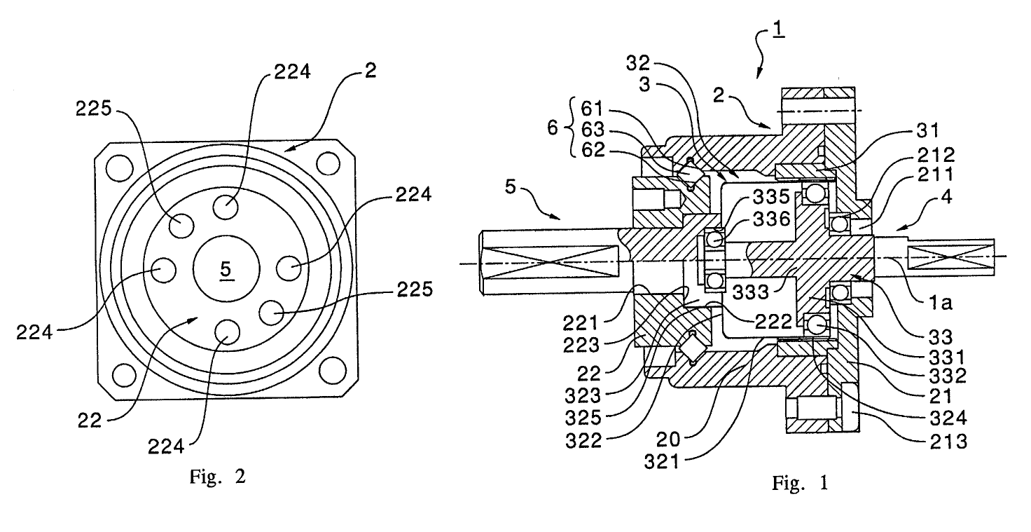

FIGS. 1 and 2 are a sectional view and a end view of a wave gear drive unit of this example. As shown in these drawings, the wave gear drive unit 1 has a unit case 2 and a wave reduction gear mechanism 3 disposed inside the unit case 2, and input shaft 4 and output shaft 5 arranged coaxially to the wave reduction gear mechanism 3 along a unit axial line 1a.

The unit case 2 has an annular case body 20, a first end plate 21 attached on one end of the case body 20, and a second end plate 22 rotatably supported on the other end of the case body 20. The wave reduction gear mechanism 3 has a circular rigid internal gear 31, a cup-shaped flexible external gear 32, and a wave generator 33 for flexing the flexible external gear radially to mesh partially with the rigid internal gear 31 and for moving meshing portions of these two gears 31,32 circumferentially.

The wave generator 33 of this example has an elliptical shape, which flexes the flexible external gear elliptically to mesh partially with the rigid internal gear 31 at both ends of the major axis of the elliptical shape. The cup-shaped flexible external gear 32 has an annular body 321, a circular diaphragm plate 322 extending radially and inward from one end of the body 321, a disk-shaped boss 323 integrally formed on an inner peripheral edge of the diaphragm plate 322, and external teeth 324 formed on an outer circumferential surface portion of the body 321 at its open end side.

The wave generator 33 of this example has an elliptical rigid cam plate 331 and a wave bearing 332 fixed on an outer circumferential surface of the rigid cam plate 331. The rigid cam plate 331 is formed on its end surface with the input shaft 4 integrally. Namely, the rigid cam plate 331 and the input shaft 4 are manufactured as a single component part. The input shaft 4 extends from the end of the rigid cam plate 331 to penetrate through the center of the first end plate 21 in a manner that it is rotatably supported by a bearing 212, and projects outside the unit case. The tip end of the input shaft 4 is connected to a motor or the like (not shown) . The first end plate 21 is fixed on the end of the case body 20 by means of mounting screws 213.

The rigid cam plate 331 is also formed on the other end surface with a shaft 333 extending coaxially. The end portion of this shaft 333 is supported rotatably by a bearing 336 which is mounted on an circular recess portion 335 formed on the end of the boss 323.

On the other hand, the output shaft 5 of this example is integrally formed on the boss 323 of the flexible external gear 32. In other words, the flexible external gear 32 and the output shaft 5 are manufactured as a single component part. The output shaft 5 extends to penetrate through a through-hole 221 formed on the center of the second end plate 22, the tip end of which projects outside from the second end plate 22. Therefore, in comparison with a case where the output shaft 5 is connected to the outside end surface of the second end plate 22 by means of fastening bolts and the like, the connecting portion of the output shaft to the boss is simple, the number of the parts is small, and the assembling operation is easy.

The boss 323 has an outer diameter one size larger than that of the output shaft 5 and is formed on its outer circimferential surface with an external thread portion 325. The through-hole 221 of the second end plate 22 is formed with a large-diameter portion which has an internal thread portion 222 formed on its inner circumferential surface. Ajecent to this portion, a circular stepped surface 223 is also formed.

Thus, by screwing the boss 323 into the second end plate 5, the flexible external gear 32 can be fixedly connected to the second end plate 22. Compared with a case where these parts are connected by means of fastening bolts and the like, connecting structure of these parts is simple, the number of the parts is small, and the assembling operation is easy. Further, different from the case where the output shaft is manufactured separately from the flexible external gear and is connected thereto by means of fastening bolts or the like, slip does not occur between the flexible external gear and the second end plate, and a high torque transfer can be assured.

In this example, the second end plate 22 is formed on its outside end surface with bolt holes 224 for fastening a load-side member (not shown) to this end plate. Further, a pair of holes 25 are also formed on the outside end surface of the second end plate 22. These holes 25 are used as a detent so that driving operation of these parts can easily be carried out.

Next, the second end plate 22 is rotatably supported on the inner circumferential surface of the case body 20 via a cross roller bearing 6. The cross roller bearing 6 has a V-shaped outer raceway surface 61 formed on the inner circumferential surface of the case body 20, a V-shaped inner raceway surface 62 formed on the outer circumferential surface of the second end plate 22, and rollers 63 accommodated rotatably between these raceway surfaces 61, 62. Thus, there is no need to assemble another parts of outer race and inner race, but the case body 20 and the second end plate 22 serve as the outer and inner races, respectively. Whereby, the cross roller bearing can be made simple in structure with less number of assembling parts, so that it can be assembled easily.

As mentioned above, according to the wave gear drive unit of this invention, the output shaft is integrally formed on the boss of the cup-shaped flexible external gear. Hence, in comparison with a case where the output shaft is connected to the second end plate by means of fastening bolts or the like, the structure of the wave gear drive unit is simplified, the number of component parts thereof is reduced, and the assembling thereof is easy.

Further, the boss of the flexible external gear is directly screwed into the second end plate, so that the connecting portion of these parts is simplified and the number of assembled parts for the connecting portion is reduced, to thereby make assembling operation simplified.

In addition, the cross roller bearing for rotataby supporting the second end plate is constituted by the outer raceway surface on the unit case and the inner raceway surface on the second end plate, so that the structure thereof is simplified, the number of component parts thereof is reduced, to thereby make the assembling operation easily.

Furthermore, the input shaft is also formed integrally on the wave generator, so that the connecting portion of the input shaft is simplified in structure, and fastening members and connecting operation of the connecting portion are eliminated, whereby assembling of these parts becomes easy.

What is claimed is:

1. a wave gear drive unit comprising:
a unit case;
a wave reduction gear mechanism disposed inside the unit case;
an input shaft;
an output shaft;
wherein the unit case has an annular case body, a first end plate attached on one end of the case body, and a second end plate rotatably supported on the other end of the case body, wherein the wave reduction gear mechanism has a circular rigid internal gear, a cup-shaped flexbile external gear disposed inside the rigid internal gear, a wave generator for flexing the flexible external gear radially to mesh it partially with the rigid internal gear and for moving meshing portions of these gears circumferentially,
wherein the input shaft is conencted coaxially with the wave generator and penetrates rotataby through the first end plate,
wherein the flexible external gear has an annular body, a circular diaphragm plate extending radially and inward from one end of the body, and a disk-shaped boss integrally formed on an inner peripheral edge of the diaphragm plate, and
wherein the output shaft is integrally formed on the boss and penetrates through the second end plate.

2. A wave gear drive unit according to claim 1, wherein the boss is screwed into the second end plate.

3. A wave gear drive unit according to claim 1, further comprising a cross roller bearing for supporting the second end plate rotatably on the case body, wherein
the cross roller bearing has an outer raceway surface formed on an inner circumferential surface of the case body, an inner raceway surface formed on an outer circumferential surface of the second end plate, and a plurality of rollers accommodated between these raceway surfaces.

4. A wave gear drive unit according to claim 1, wherein the wave generator is formed integrally with the input shaft.
